(19) United States
(12) Patent Application Publication
(10) Pub. No.: US 2026/0137073 A1
(43) Pub. Date: May 21, 2026

(54) Tool For Removing Unwanted Plants Without Using Toxic Chemicals and Method Thereof

(71) Applicant: Jiasheng Wu, Reading, MA (US)

(72) Inventor: Jiasheng Wu, Reading, MA (US)

(21) Appl. No.: 18/982,114

(22) Filed: Dec. 16, 2024

Related U.S. Application Data
(60) Provisional application No. 63/721,180, filed on Nov. 15, 2024.

(51) Int. Cl. A01M 21/04; B33Y 80/00; B65D 41/02

(52) U.S. Cl. CPC A01M 21/043; B65D 41/02; B33Y 80/00

(57) ABSTRACT

A knotweed terminating tool device and a method for killing knotweed with common or table salt is disclosed. When the saltwater flows out from tool device is inserted to the root area of the knotweed, the salt is absorbed into its entire body including all stems, no stem will survive to spread.

### CROSS-REFERENCE TO RELATED APPLICATIONS

This patent application claims the priority of the U.S. Provisional Patent Application No. 63/721,180, entitled “A tool for removing weed without toxic chemicals” filed on Nov. 15, 2024, the entirety of which is thus incorporated by reference.

### BACKGROUND OF THE INVENTION

In North America and Europe, especially in the United Kingdom and the United States, people often use weed killing chemicals to kill weeds and control weed spreading. But knotweed grows in large, dense thickets, they reach 4-13 feet tall, with bamboo-like, green-reddish canes and branched clusters. They reproduce mainly via extensive roots and rhizomes. These plants are highly aggressive, clogging waterways, eroding banks, and even growing through building foundations. There four knotweeds, three are in the Fallopia genus: giant knotweed, hybrid knotweed (also called Bohemian knotweed), and itadori knotweed (also called Japanese knotweed). The fourth is less closely related and is called Himalayan knotweed or Persicaria wallichii. They are all large, robust perennials that spread by long creeping rhizomes to form dense thickets. Due to their lack of natural predators, and their ability to spread by root and stem fragments, invasive knotweed species have spread and become widely established throughout North America and Europe. Knotweed clones can completely clog small waterways and displace streamside vegetation, increasing bank erosion and lowering the quality of riparian habitat for fish and wildlife. Rapid spring growth and deep, extensive roots enable knotweed to outcompete most other plants, even small trees and shrubs. Knotweeds can tolerate partial shade and are most competitive in moist, rich soil.

Some local governments require landowners to control knotweeds. Control of knotweed is challenging and often requires a watershed approach to be effective. It is still very difficult to eradicate it by traditional weed killing chemicals and coordinated burning, because its roots are deep in the soil. Unless chemical herbicides are used to completely kill the roots, it will soon grow out again. But using large scale herbicides can cause serious damage to water and land, causing environmental disaster. There is a great need to develop a simple and economic way in fighting and controlling knotweeds.

### SUMMARY OF THE INVENTION

The present invention discloses a tool designed for elimination of knotweeds with a pollution-free and simple method. The tool is a wedge-shaped insert around 23 cm long and 5 cm wide 2.5 cm thick with openings at the pointed end. When using it, just insert the tool into the soil near the root of the knotweed, fill the wedge half full of edible salt into the cavity of the insert, and then fill it with water. The salt water in the insert will slowly flow out from the small holes below and penetrate to the weed's roots, the root system of the knotweed will absorb the salt water. After the salt water diffuses through the plant's circulatory system to the stems, leaves, and roots of the whole plant, the entire knotweed will dehydrate and die completely, and it will not grow again. After the salt water is absorbed by the root system of the knotweed, it will stay inside the plant, and the remaining small amount of salt water will not pollute the soil.

### BRIEF DESCRIPTION OF DRAWINGS

The disclosed application will be described with reference to the accompanying drawings, which show important sample embodiments of the invention and which are incorporated in the specification hereof by reference, wherein:

FIG. 1A is a perspective view of an example weed terminating wedge-insert in accordance with this application.

FIG. 1B is a side view of an example weed terminating wedge-insert in accordance with this application.

FIG. 1C is a front view of an example weed terminating wedge-insert in accordance with this application.

FIG. 1D is a sectional view of an example weed terminating wedge-insert in accordance with this application.

FIG. 1E is another side view of an example weed terminating wedge-insert in accordance with this application.

FIG. 2 is a real prototype of an example of weed terminating wedge-insert in accordance with this application.

FIG. 3 is an example flow chart of a method of eliminating weeds by using the device described in this application.

### DETAILED DESCRIPTION OF THE INVENTION

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements but may include other elements not expressly listed or inherent to such process, method, article, apparatus, or composition.

It is contemplated and intended that the designs can be made using any suitable material, such as wood, metal, plastic, and may be made by a process of molding, carving or assembling. for clarity reason, the examples are given based on 3D printed device, but an ordinary person in the art would know the variations to modify the design to make a

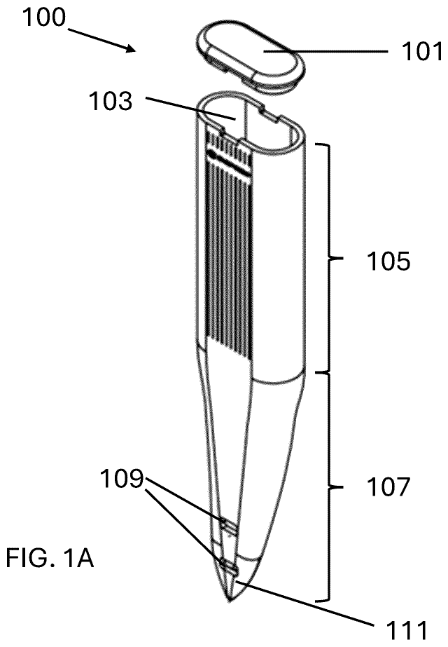

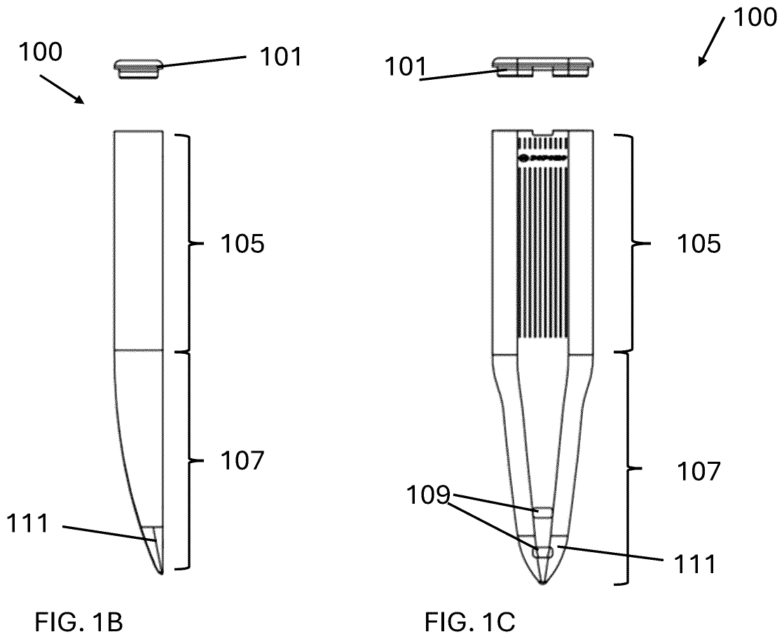

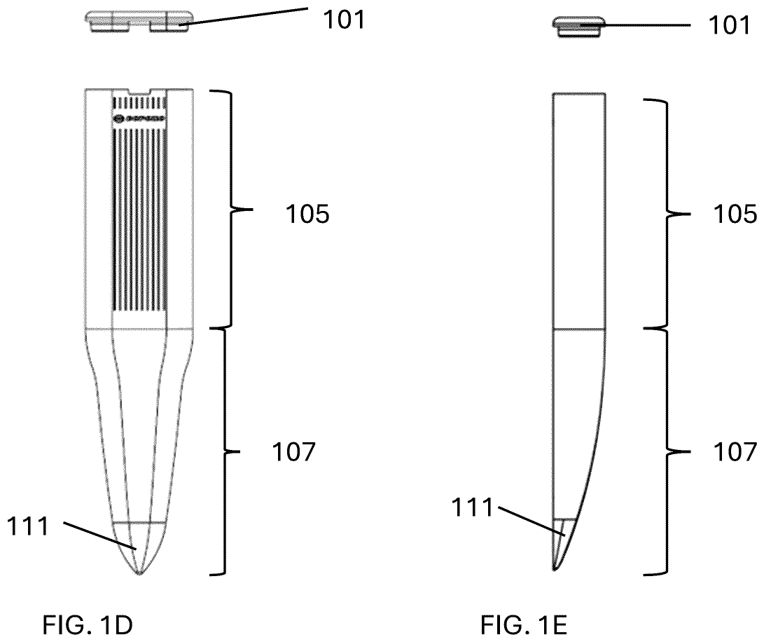

FIG. 1A shows a wedge-shaped insert device 100 that includes an upper body 105 and lower body 107. The upper body 105 is a tubular and the lower body 107 gradually reduces dimensional size into a sharply pointed end 111, a wedge-shaped structure. Insert device 100 is a housing structure that includes housing space 103 for holding water and salt. The entire insert device may be formed by one integral piece of material to form thin walls surrounding space 103, or by multiple pieces being assembled together. On the lower and pointed area of lower body 107, one or more apertures 109 are configured to connect with space 103 so that liquid contained in space 103 can flow out through the apertures. A matching shaped cap 101 is configured to seal the top opening of body 105 when the cap is tightly pressed onto the entry opening of the body 105. On the top edge of the upper body 105, small notches 113 and 114 may be configured so that even with the cap 101 pressed on top of body 105, the air pressure difference between the top of the insert device and the lower aperture 109 is evened and liquid content inside device 100 can still flow out.

FIGS. 1B and 1E show side views of device 100, while the upper body 105 may be an elongated rectangular tubular structure, the lower body 107 may have a non-curved front side 117 and a curved peripheral side 115 in forming the pointed end 111. FIG. 1C further shows a front view of device 100, the front side 117 is straight, peripheral and surrounding sides 115 are sloped to form sharp pointed end 111. On the front side 117, two holes 109 are configured for liquid flowing out from inside space 103. A notch or gap 114 is configured at the front side 117 and a similar notch or gap 119 is configured on the cap 101 to allow air flow into space 103. FIG. 1D shows a sectional view of device 100. A space 103 is formed inside walls 105 and 107, where the lower walls are formed by straight front 117 and curved peripheral 115 shaped. However, the shape of straight front 117 is also in a pointed shape on both sides to form the pointed end 111. Both upper body 105 and lower body 107 form an entire empty space 103 where the holes 109 at the pointed end 111 and notches 113, 114 and 118, 119 between the cap 101 and upper body 105 allow the inside space 103 to connect with outside air space.

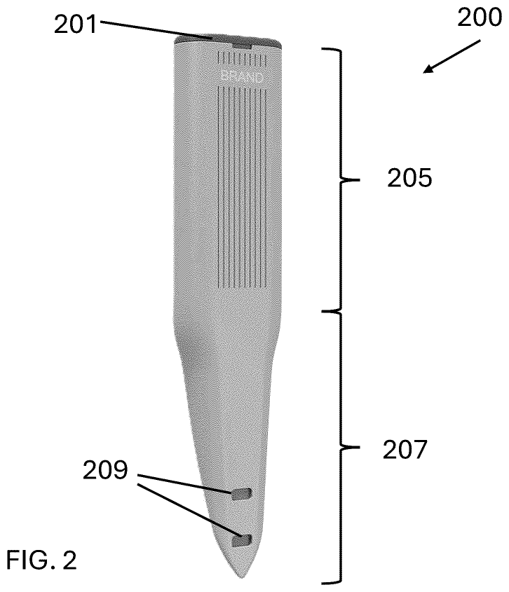

Device 100 may be made by 3D printing technology or by traditional molding of durable plastic material or carving of wood or metal material. FIG. 2 shows a 3D printed example with durable plastic materials. The top opening may be preferably sized at 51×25 mm with the tubular wall of 2 mm or more thickness. The holes at the end point may be 5×10 mm and the upper tubular height may be configured 115 mm long and the entire device length 230 mm long.

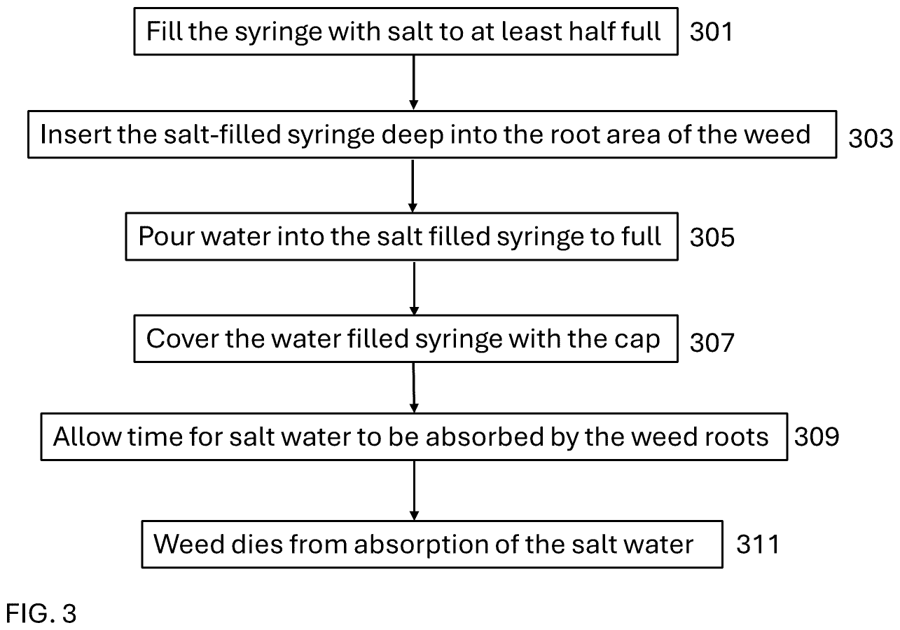

In reference to FIG. 3, to eliminate weeds, particularly the aggressive knotweed, first fill the tubular insert device 100 with common salt or table salt to ⅓ full at step 301, about 130 mm length point from the top, then insert the salt filled insert device 100 into the soil of the weed's root area at step 303, then fill the insert device 100 with water at step 305, pressing on the cap onto the insert device at step 307, the water will then slowly dissolve the salt and flow out into the root area of the weed plant at step 309. The high salt water will be absorbed into the weed plant and be transported to the entire plant body. After three or four days, the entire body of the weed plant will die from dehydration by the high salt absorbed and there will be no stem that is still alive to spread to other areas.

The any other salt may also be used, weed killers and other suitable chemicals.

Alternatively, one may first seal the two bottom holes and fill the insert device with salt water that contains 48 grams of salt, seal the cap's gap and unseal the bottom holes, and insert the saltwater containing insert to the root area of the weeds, and unseal the cap gap to allow the saltwater flow to the root and be absorbed by the root.

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

None of the descriptions in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

1. A unwanted plant terminating tool device, comprising:
a housing body with a wedge-like shape having an upper housing body and lower housing body formed by a wall of thickness about 2-5 mm, and forming a housing space;
a top opening being configured at said upper housing body;
a sharp pointed end being configured at said lower housing body, said sharp pointed end being formed by a straight front side and curved surrounding sides;
at least one hole being configured on said sharp pointed end and connecting said housing space; and
a cap being configured to tightly fit onto said top opening.

2. The unwanted plant terminating tool device of claim 1, wherein said top opening is configured with a notch.

3. The unwanted plant terminating tool device of claim 1, wherein said cap is configured with a notch.

4. The unwanted plant terminating tool device of claim 1, wherein said housing body is of vertical dimension (L×W×H) about 51 mm×25 mm×230 mm.

5. A method of making said unwanted plant terminating tool device of claim 1 is by 3D printing.

6. A method of terminating unwanted plants comprising the steps of:
filling an unwanted plant terminating tool device of claim 1 with common salt to one third full;
inserting said salt filled unwanted plant terminating device into the soil of an unwanted plant's root area;
pouring water into said salt filled unwanted plant terminating device to full;
capping said water-filled unwanted plant terminating device;
allowing water flow through the hole at the pointed end of said unwanted plant terminating tool device; and
waiting for 3-5 days for the unwanted plant to absorb the salt into its entire stems.

7. The method of claim 6, wherein said unwanted plant is knotweed.

8. The method of claim 6, wherein said common salt is table salt.

9. The method of claim 6, wherein said common salt is a mixture of chemicals.

10. The method of claim 6, wherein the step of salt filling and the step of water filling are combined into one step by first blocking the holes at the pointed end before inserting unwanted plant terminating device to the root area of an unwanted plant.
